(19) United States
(12) Patent Application Publication
(10) Pub. No.: US 2016/0189245 A1
(43) Pub. Date: Jun. 30, 2016

(54) Method and Computer Software and System for Customizing and Delivering Marketing Platforms

(71) Applicants: Alejandro Rosman, Miami, FL (US); Ivan Rosman, Miami, FL (US)

(72) Inventors: Alejandro Rosman, Miami, FL (US); Ivan Rosman, Miami, FL (US)

(21) Appl. No.: 14/800,661

(22) Filed: Jul. 15, 2015

Related U.S. Application Data
(60) Provisional application No. 62/022,210, filed on Jul. 9, 2014.

(51) Int. Cl. G06Q 30/02; G06Q 50/16

(52) U.S. Cl. CPC G06Q 30/0276; G06Q 50/167

(57) ABSTRACT

system for marketing real estate and other projects. The invention comprises three main steps: 1) In the first step, the user selects the project to be promoted. If the project is not in the database, the user can create a new project by adding a new project name, then upload all of the information related to the project; 2) In the second step, the user selects an email or website marketing template, which is populated with existing or newly created information from the database/system, resulting in the automatic layout of the information in the selected template; and 3) In the third step, the user selects contacts, from a previously uploaded file or contact list, of intended recipients of the email or other web based delivery platform.

### CROSS-REFERENCE TO RELATED APPLICATIONS

This application claims benefit of U.S. Provisional Application No. 62/002,210, filed on Jul. 9, 2014. The entire disclosure of this prior application is hereby incorporated by reference.

### STATEMENT REGARDING FEDERALLY SPONSORED RESEARCH OR DEVELOPMENT

This invention has been created without the sponsorship or funding of any federally sponsored research or development program.

### FIELD OF INVENTION

The present invention relates generally to an online marketing platform for real estate and other professional fields.

### BACKGROUND OF THE INVENTION

In the marketing industry, there are various means of compiling, packaging, and publishing marketing materials and information. In particular in the real estate industry, marketing is limited to microsites that point a user to various links or locations for information regarding the development and sale/purchase of real estate. Real estate professionals are forced to pull marketing materials and databases from various locations in order to put together a marketing package for publication to potential buyers and sellers. This software and system provides a solution for effectively promoting existing and emerging real estate projects by pooling and housing information databases, customer contact lists, and marketing platforms in one system, under one umbrella. Real estate professionals can utilize this system to mass market existing and preconstruction projects as well as customize marketing for a targeted consumer group, without having to search for information such as: lists of existing and pre-construction projects in a particular area or region, floor plans, 3D renderings, virtual tour videos, digital brochures, realtor and developer information, etc.

The present invention serves to minimize the time real estate professionals spend looking for and compiling information for marketing purposes, and maximize the time a real estate professional spends connecting with potential and/or actual buyers/sellers. This invention is not limited to the sphere of real estate and may be adaptable to marketing products and services in a variety of other industries.

### SUMMARY OF THE INVENTION

This invention includes merging a complete database of information relating to existing and preconstruction projects in, for example, Florida, with a digital software that creates enhanced digital newsletters “e-blasts”/“e-flyers”, containing each project's information. In the preferred embodiment of this invention, the target audience for this service is real estate professionals, including but not limited to real estate brokers and real estate agents who want to promote their services through an email or web based or social network campaign.

The method of this invention is comprised of three main steps: 1) In the first step, the user selects the project to be promoted. If the project is not in the database, the user can create a new project by adding a new project name, then upload all of the information related to the project; 2) In the second step, the user selects an email or website marketing template, which is populated with existing or newly created information from the database/system, resulting in the automatic layout of the information in the selected template; and 3) In the third step, the user selects contacts, from a previously uploaded file or contact list, who will receive the email or other web based delivery platform. The information received by the recipient will include the user or sender's contact information.

### BRIEF DESCRIPTION OF THE DRAWINGS

In describing the invention, reference will at times be made to the accompanying drawings in which:

FIGS. 1a-1g. FIGS. 1a throught 1f are screen shots of the software system of the present invention, outlining steps in the process for creating real estate e-blasts or other web based marketing platforms.

FIG. 2. FIG. 2 is a logic flow diagram of the software system of the present invention, showing steps in the process for creating a real estate e-blast or web based marketing platform.

FIG. 3. FIG. 3 is a logic flow diagram of the software system of the present invention, showing steps in the process for creating a real estate project in the database.

FIG. 4. FIG. 4 is a diagram illustrating the steps or process for merging user information to existing real estate project information and creating one single file.

FIG. 5. FIG. 5 shows examples of existing real estate marketing templates where Template A may be the logo of the real estate project; Template B may be pictures; Template C may be links to download files; and Template D may be a written description of the project.

### DESCRIPTION OF THE INVENTION

Before the subject invention is described further, it is to be understood that the invention is not limited to the particular embodiments of the invention described below, as variations of the particular embodiments may be made and still fall within the scope of the invention. It is also to be understood that the terminology employed is for the purpose of describing particular embodiments, and is not intended to be limiting.

The details of one or more embodiments of the invention are set forth in the accompanying drawings and the description below. Other features, objects, and advantages of the invention will be apparent from the description and drawings, and from the claims. In the following description, numerous specific details are set forth to provide a thorough understanding of the embodiments. One skilled in the art to which this invention belongs will recognize, however, that the techniques described can be practiced without one or more of the specific details, or with other methods, components, materials, etc. In other instances, well known structures, materials or operations are not shown or described in detail to avoid obscuring certain aspects.

In this specification, the singular forms “a,” “an” and “the” include plural reference unless the context clearly dictates otherwise. Unless defined otherwise, all technical and scientific terms used herein have the same meaning as commonly understood to one of ordinary skill in the art to which this invention belongs.

The present invention is a web based software system that allows users to create custom real estate projects, marketing e-blasts, personalized emails, custom websites, e-flyers, and other web based marketing platforms by either using the system's existing database or uploading information manually. The marketing e-blasts created through the processes of the system are delivered via email with graphically enhanced hyperlinks.

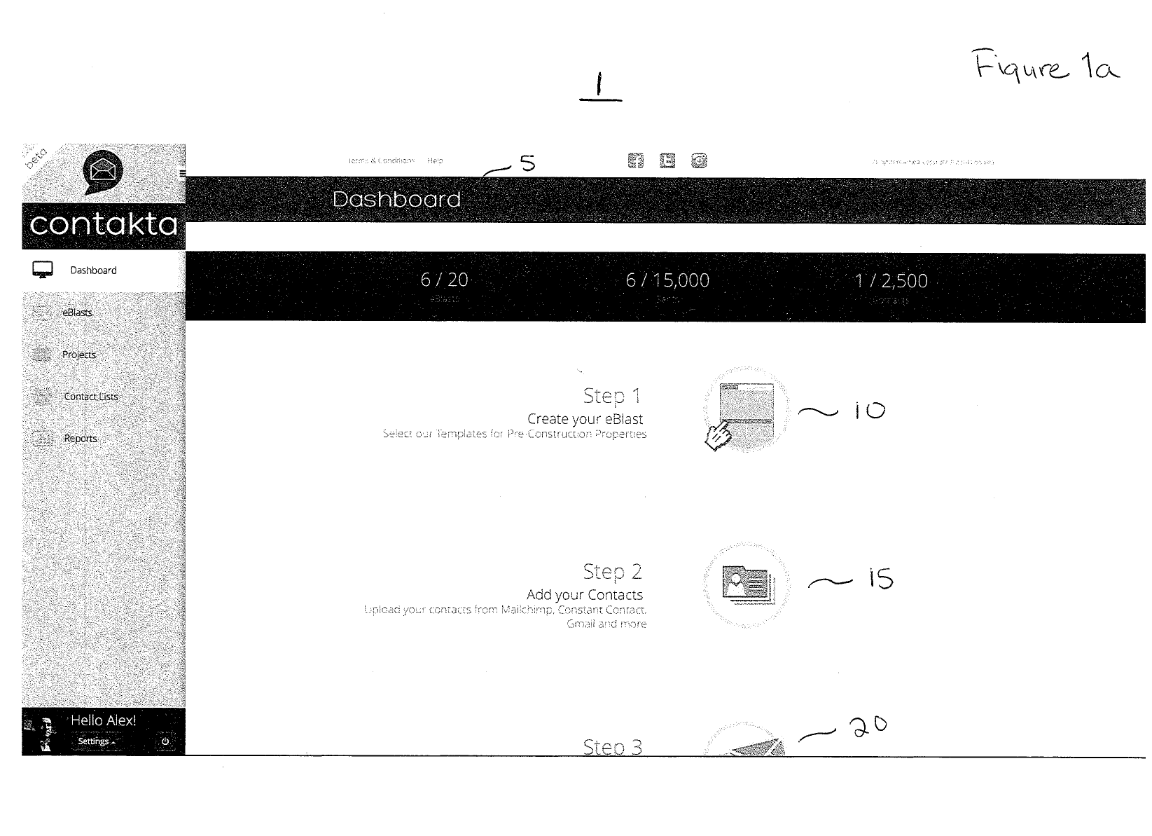

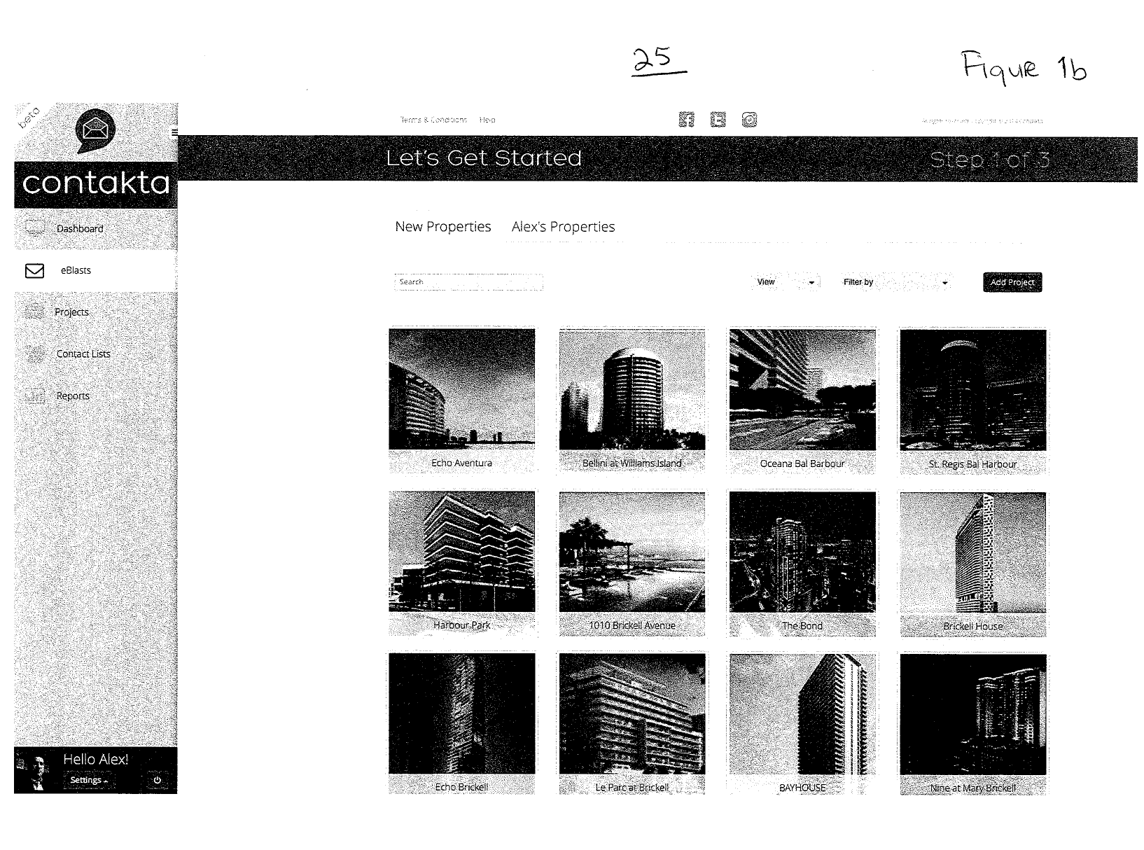

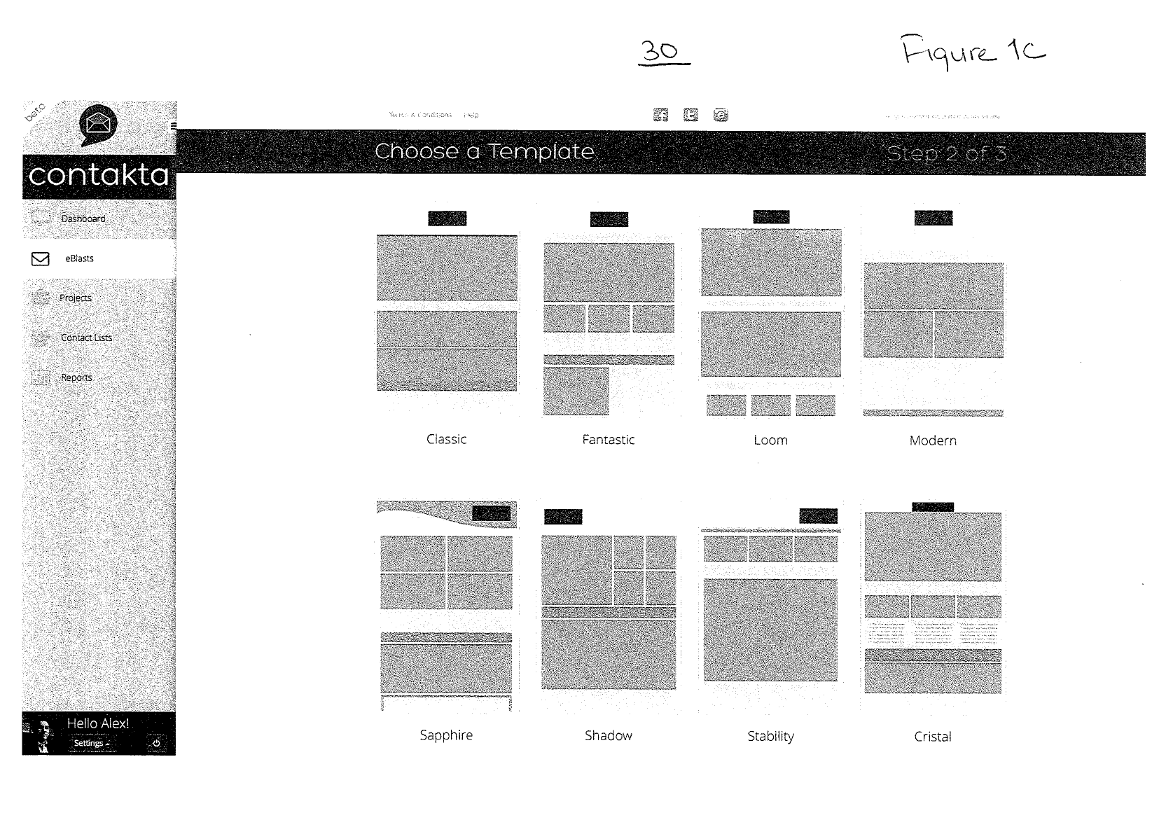

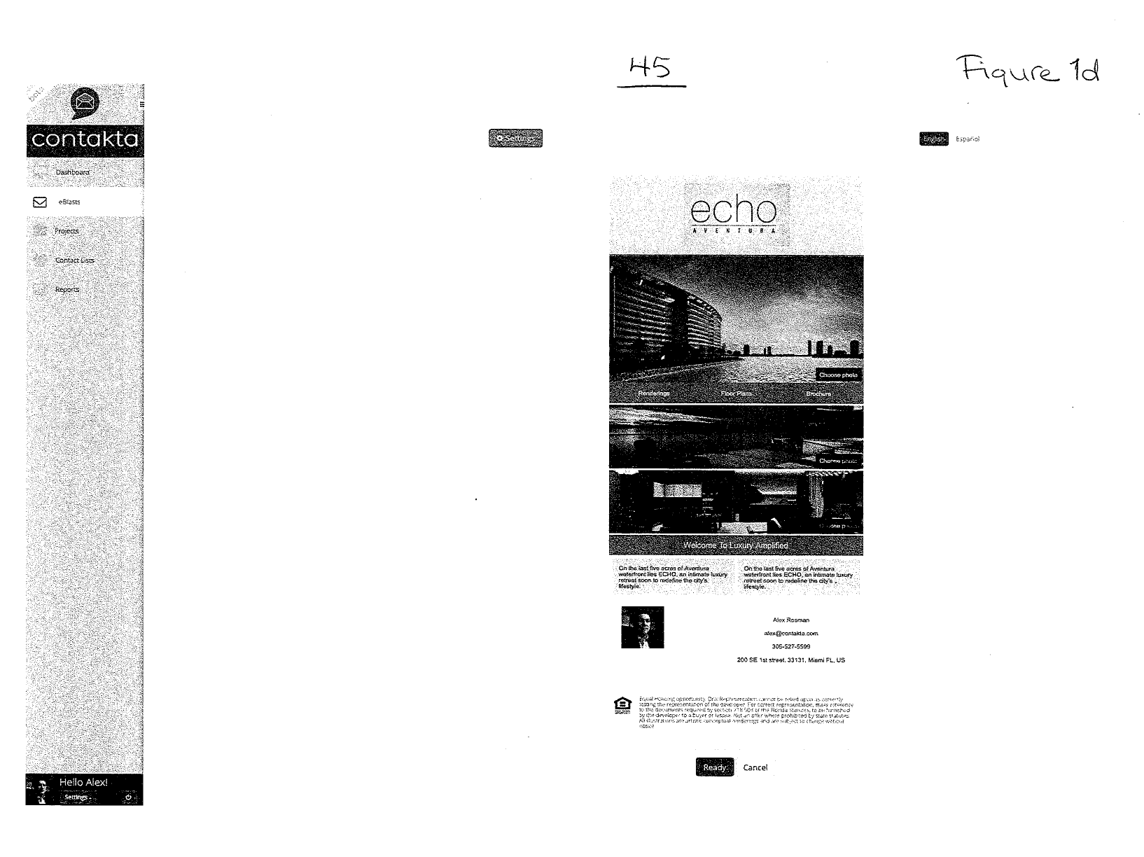

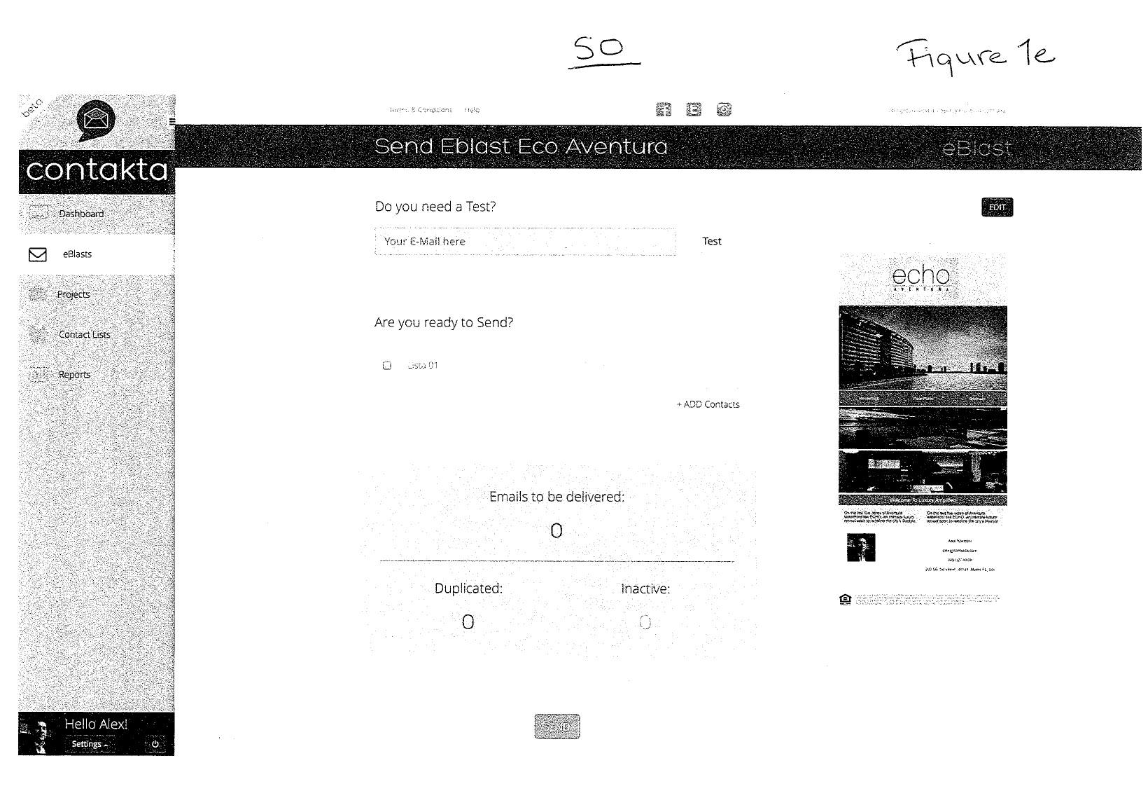

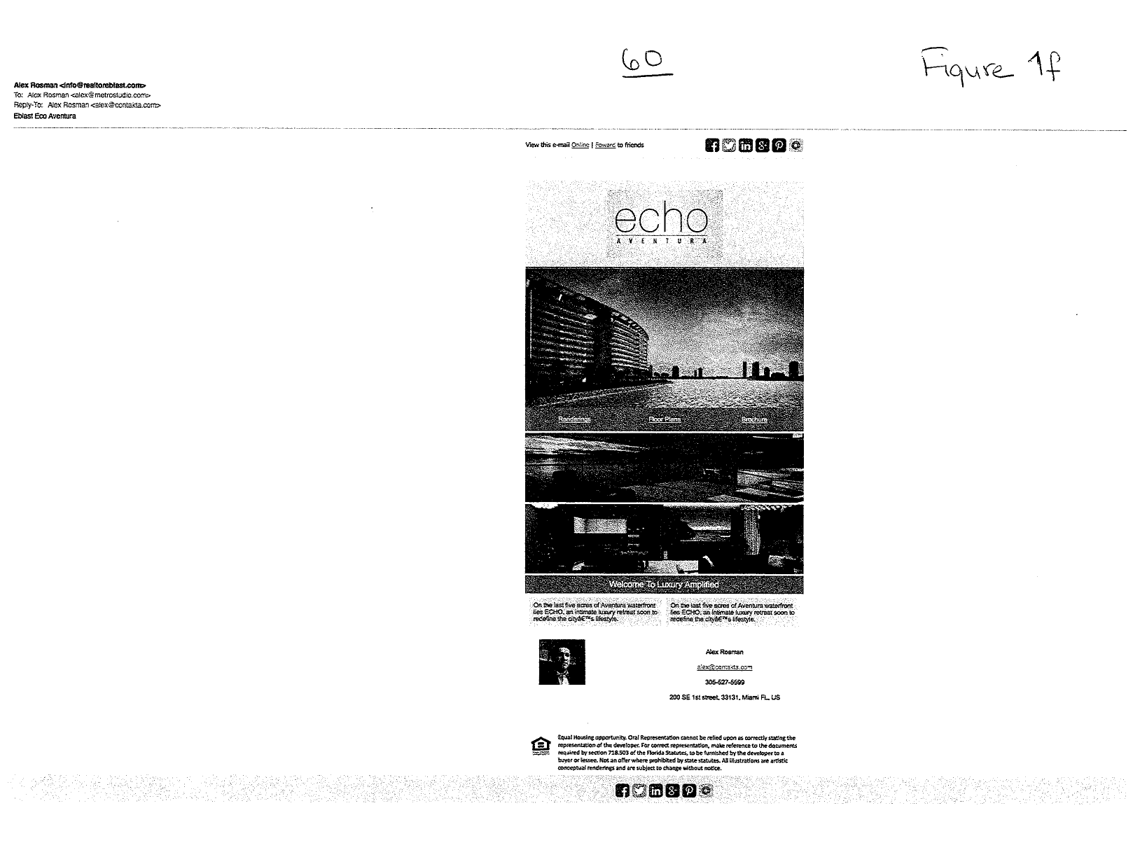

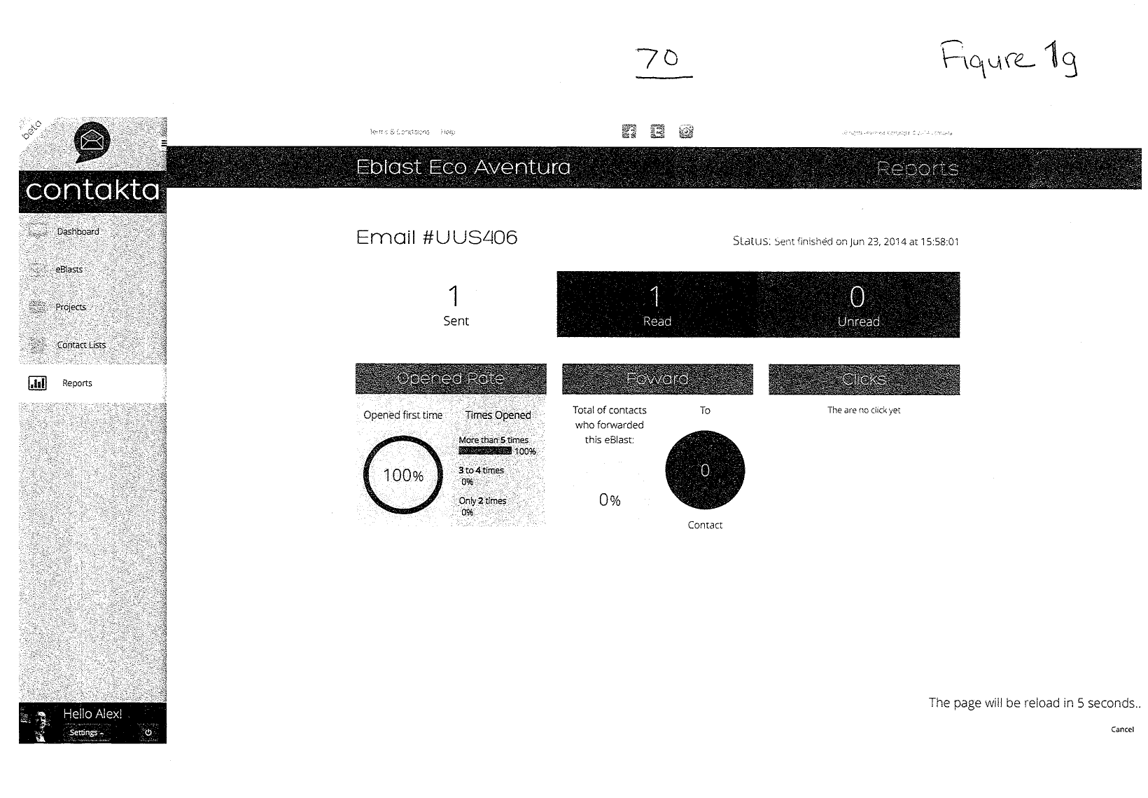

FIGS. 1a-g, illustrate the steps in the process for creating real estate e-blasts as well as the components of the online marketing platform system. To begin the process, a user accesses the online marketing platform system 1 and is directed to the main dashboard 5 where the user is able to create an account in the system by inputting the user's email address and selecting a password. Once the account is created, the user can access the existing database of preconstruction or other projects 25, as shown in FIG. 1b, and begin to browse the information or begin the steps for creating a web-based marketing platform.

The database 25 includes information such as: floor plans, 3D renderings, fact sheets, project's views, pictures, videos, electronic brochures and a variety of other marketing material created by the project's Developer for purposes of promoting and advertising properties for sale before construction commences and/or also of existing real estate projects.

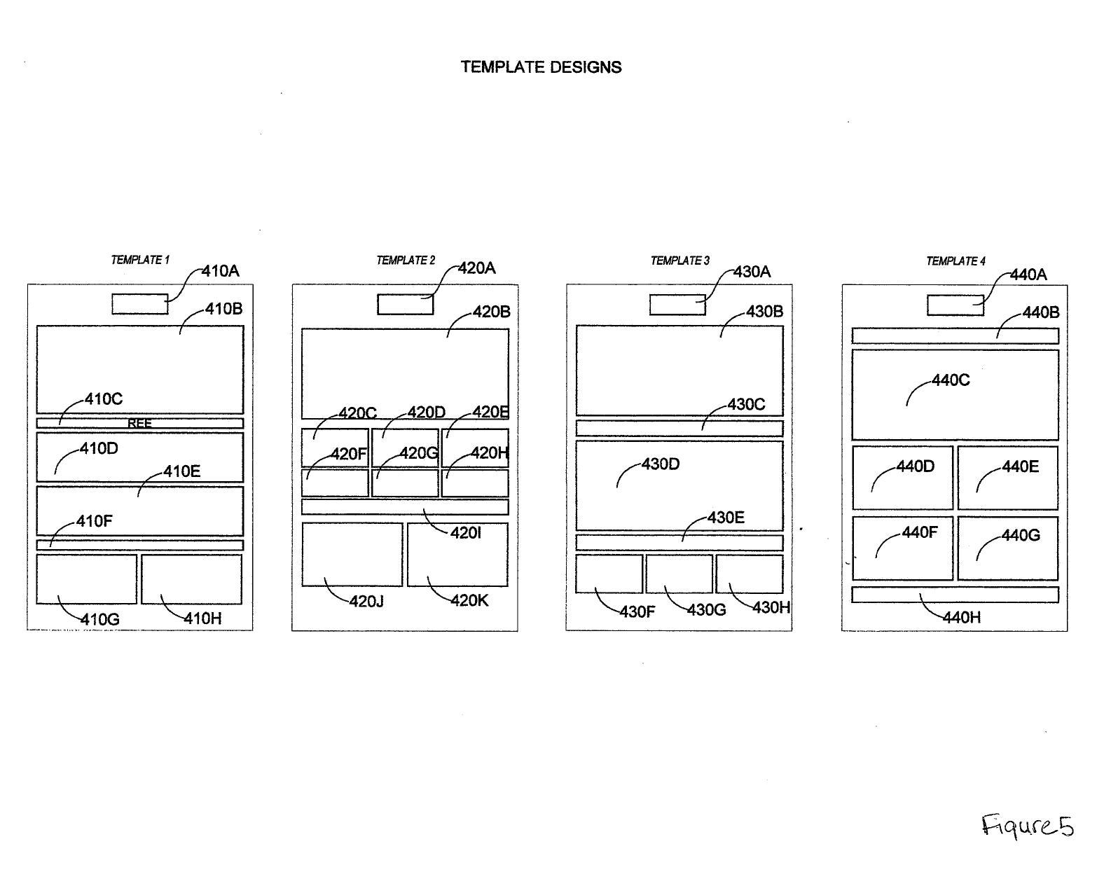

Once the user selects the project that will be promoted through the e-blast 10, he/she can select a real estate template 30, as shown in FIG. 1c, that has been pre-loaded, formatted, and automatically optimized to be populated or combined with information from the existing database 25 as previously described. The schematics and layout of the real estate template 30 is also illustrated in FIG. 5.

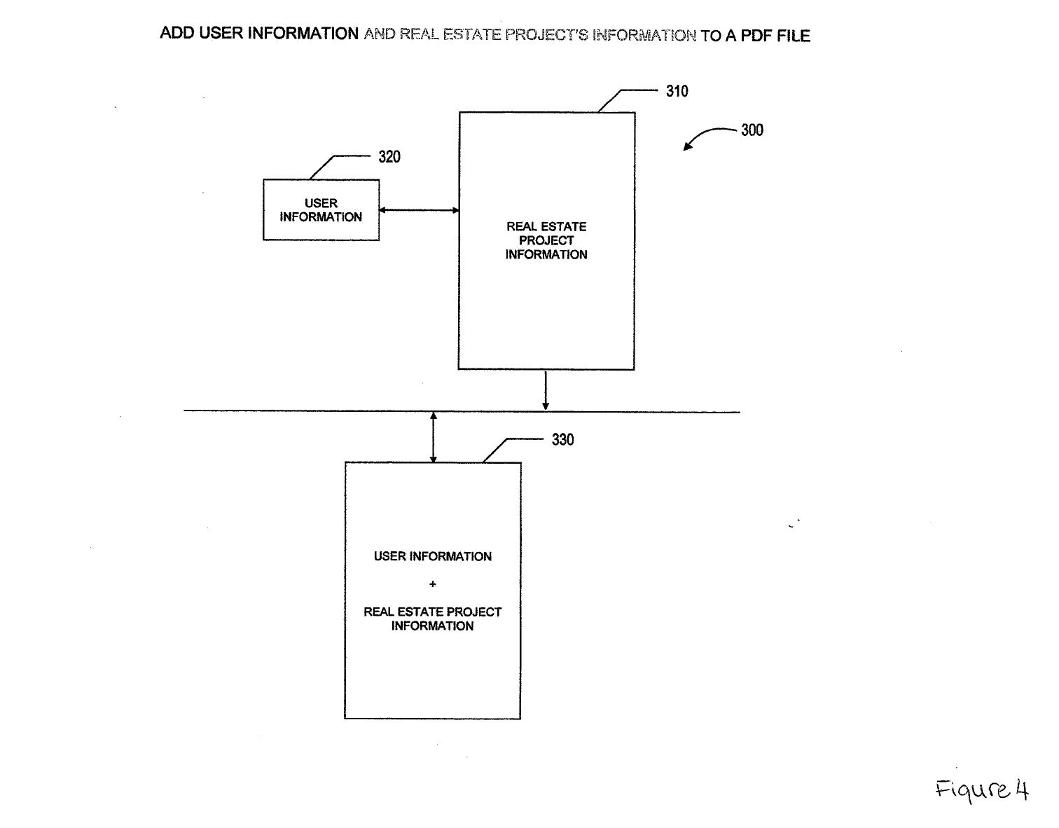

The selected template 30 (see templates 1, 2, 3 or in FIG. 5) will include links to downloadable materials or information (including in Adobe Acrobat PDF format), which include the user's information (such as their full name, email address, physical address, business name, company logo, profile picture, social links and any other information the user may desire to add). The user may choose to add this information in PDF format as illustrated in FIG. 4.

After selecting the template 30, the user will be able to add contacts of potential buyers and/or sellers who will be the addressees/recipients of the emails and/or marketing platforms 15, as shown in FIG. 1a. The addressees may be added manually or by automatically importing contacts from other email software such as Gmail, Hotmail, Yahoo Mail, etc. or from a spreadsheet formatted in Excel, a VCS file, etc. After adding the addressees' information, the email is ready to be sent 20, as shown in FIG. 1a as step 3. For example, FIG. 1d shows the finished e-blast for project “echo Aventura” 45 before it is sent and FIG. 1e shows the final step before the finished e-blast is sent to recipients 50. FIG. 1f shows the finished e-blast for project “echo Aventura” 45 after it has been sent to recipients 60.

As an additional feature, a user is able to review reports 70 reflecting when and how many addressees opened the emails and the number of files downloaded from the link included in the email, among other statistics. These reports 70, as illustrated in FIG. 1g, are accessed by the user from the dashboard 5 of the online marketing platform.

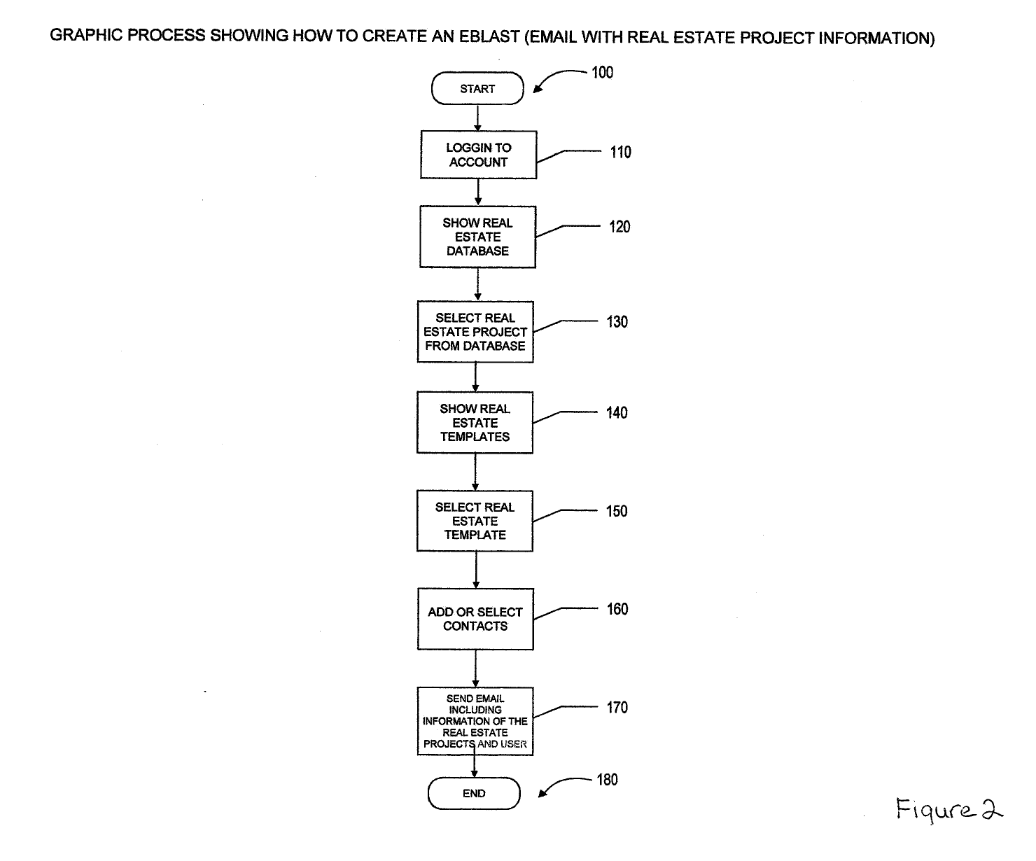

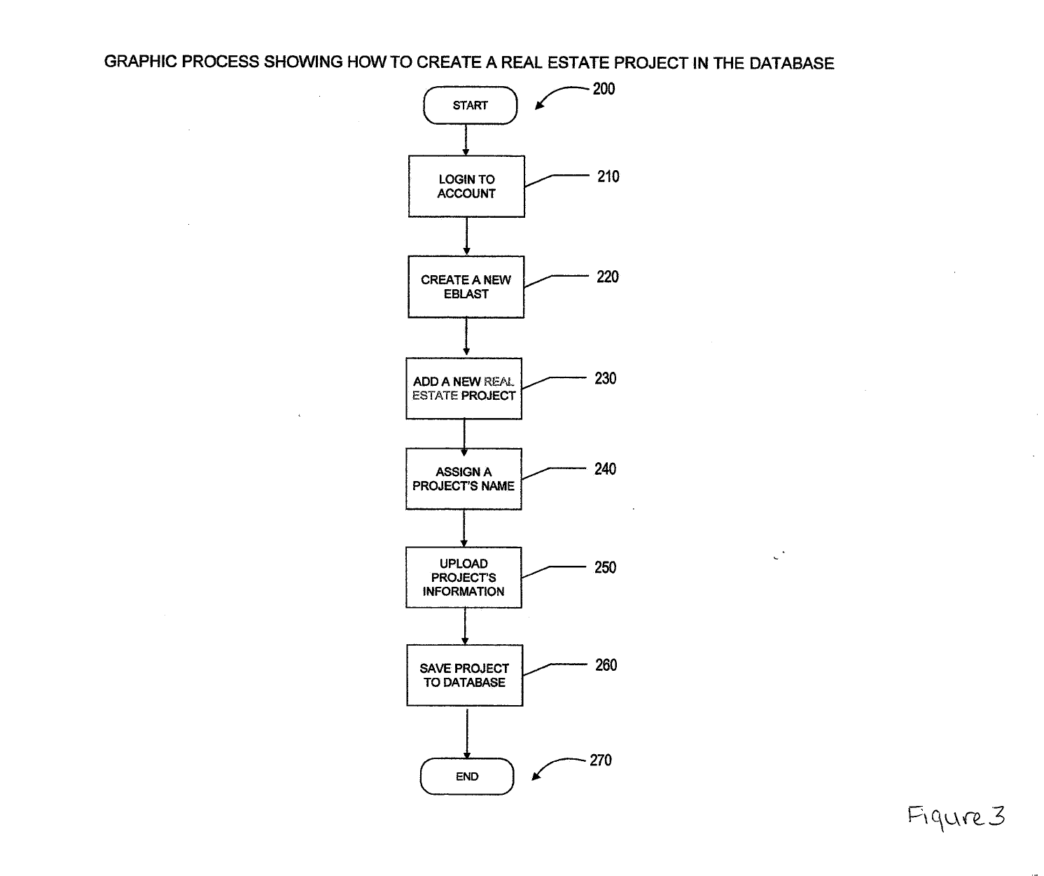

FIG. 2 is a logic flow diagram showing the detailed steps involved in creating an e-blast using the online marketing system as previously described in FIGS. 1a-1g. The user starts the processing by accessing the online marketing platform system 100, and is prompted to create an account 105 or log into an account 110. When the user either creates an account 105 or logs into an account 110, the system then takes him to the Real Estate Database 120, where he is able to browse pre-loaded Real Estate Projects. In order to move forward with the process, the user must decide whether or not to select a Real Estate Project 130 from the database 120. If after browsing the Real Estate Database, the user selects a project, then he is directed to a tab displaying Real Estate Templates 140. If the user decides not to select a project from the Real Estate Database, the system navigates him to add a new template 220, which is further described in FIG. 3. Upon browsing the options for the Real Estate Templates, the user is prompted to select a template 150. If the user chooses to select a Real Estate Template, the system displays his selection from the options 155, which options are further illustrated in FIG. 5, 400. In the event the user decides not to select a Real Estate Template, he has the option to go back to the tab showing the Real Estate Templates 140 or navigate to add a new Real Estate Project 220 as shown in FIG. 3. The user then determines whether to manually add new contacts to receive the e-blast or whether to import contacts from an existing list or database of contacts 160. Whether the user manually adds contacts 164 or imports contacts 162, the list is finalized and the information is inputted into the online marketing platform. The system then prompts the user to choose whether to create an e-blast for dissemination to the list of recipients 168. If the user decides to create the e-blast, an e-blast is generated, and it is then sent to 170 to the predetermined list of recipients and includes the marketing and sales information for the Real Estate Project as well as the user's information. Upon sending the e-blast, the user may choose to logout 175 and end the session 180. The user also has the option to not create an e-blast, at which point he is prompted to logout 175 and end the session 180. Instead of logging out 175, the user may also return to the system prompt to select a Real Estate Project 130 and restart the process of creating an e-blast. The online marketing system is user friendly and easy to navigate, providing the user with various options for fulfilling or accomplishing his marketing needs.

A user may also have the option to further customize templates by adding information not already pre-loaded into the template or combine features of pre-loaded templates to create a new template. A user will also be able to import a previously created template and format it to meet the standards and specifications of the system. A user may also have the option of adding information for projects not contained within the existing database or updating the information related to existing projects.

FIG. 3 is a logic flow diagram illustrating the steps involved in creating an e-blast for a real estate project that is not already pre-loaded into the online marketing platform system. The user starts 200 by logging into an existing account 210 and is prompted to choose whether to add a new Real Estate Project 220, or not. If the user selects the option to add a new Real Estate Project 220, he is then guided through the process to first add a new real estate project 230, then assign a name to the new real estate project 240, followed by uploading the project information 250, and finally saving the new project into the database 260. Once the new real estate project is saved in the online marketing platform system, the user is then prompted to create an e-blast 265. If the user opts not to create a new e-blast, then the session ends 270. Alternatively, if the user chooses to create an e-blast, he is navigated through the process for creating an e-blast 120 as described in FIG. 2. At this point in the process, the new real estate project and its features have become a part of the online marketing system's database. When the user first logs into the online marketing system, he may decline the option to add a new real estate project 220 and the system will navigate him back to the prompt to create an e-blast from the existing database 120 of real estate projects. The user is then able to follow the steps as described in FIG. 2 to complete the e-blast for this new real estate project and send it out to the intended recipients. Namely, the user has to select the new real estate project, select a template for the e-blast, then add or select contacts to receive the e-blast, and send out the e-blast to the intended recipients.

In addition, as shown in FIG. 4, a user may be able to add user information formatted in an Adobe Acrobat PDF File into the system and/or a pre-loaded template. The user may have the option to combine the user's contact and promotional information with the information for a selected real estate project into a single Adobe Acrobat PDF for delivery via email or other marketing platform to potential customers.

As shown in FIG. 5, a user has the option to use pre-loaded templates 400 solely for sending emails to potential customers or other persons. This email is distinguished from an e-blast or marketing platform. This email which is created with a pre-loaded template may be used for informational as well as promotional purposes.

As various changes can be made in the above-described subject matter without departing from the scope and the spirit of the invention, it is intended that all subject matter contained in the above description, shown in the accompanying drawings, or defined in the appended claims will be interpreted as descriptive and illustrative, and not in a limiting sense. Many modifications and variations of the present invention are possible in light of the above teachings. It is therefore to be understood that within the scope of the appended claims, the invention may be practiced otherwise than as specifically described.

### EQUIVALENTS

Those skilled in the art will recognize, or be able to ascertain using no more than routine experimentation, many equivalents to the specific embodiments of the invention described herein. Such equivalents are intended to be encompassed by the claims.

What is claimed is:

1. A web-based computer software program for compiling, housing, creating, and publishing a marketing platform for the digital promotion of real estate services comprising: a real estate professional who connects and interacts with the software program using a processing unit based device; a database of completed and pre-construction real estate projects contained within the program which is accessible via a processing unit based device; a repository of marketing templates stored within the software program from which the real estate professional can create a marketing platform; a network capable of connecting the marketing platform created by the real estate professional using the software program, with an electronic mail delivery system; and a network capable of delivering the marketing platform via electronic mail media to intended recipients.

2. The web-based computer software program in claim 1 used for compiling, housing, creating, and publishing a marketing platform for the internet promotion of goods and services for a known industry.

3. A method and process for compiling, housing, creating and publishing a marketing platform for the internet promotion of goods and services in an industry utilizing a web-based computer software program and system comprising the following steps:
A user creates an account by inputting a User ID and password;
The user accesses the web-based system
The user selects the project to be promoted.
The user selects an email or marketing template, which is populated with information from an existing database in the web-based system;
The program automatically creates a layout of the information in the selected template;
The user selects contacts, from a previously uploaded file or contact list of intended recipients of the information laid out in the template;
The user selects an email e-blast marketing platform;
The user signals the program to deliver the email containing the e-blast publishing the information laid out in the template to a list of intended recipients.
The program delivers the email and its contents to the intended recipient and stores the template created by the user for future use or reporting.

4. An integrated real estate database combined with an email system connected to a processing unit device that gives an easy solution to the real estate brokerage community to advertise existing and new real estate developments.
